(19) United States
(12) Patent Application Publication
(10) Pub. No.: US 2025/0214371 A1
(43) Pub. Date: Jul. 3, 2025

(54) Adjustable Wheel Hex Hub Assembly for Remote-Controlled Cars

(71) Applicant: Enrico Luis Romero Martinez, Minneapolis, MN (US)

(72) Inventor: Enrico Luis Romero Martinez, Minneapolis, MN (US)

(21) Appl. No.: 18/402,843

(22) Filed: Jan. 3, 2024

Related U.S. Application Data
(60) Provisional application No. 63/616,847, filed on Jan. 2, 2024.

(51) Int. Cl. B60B 3/16; B60B 3/14

(52) U.S. Cl. CPC B60B 3/16; B60B 3/145; B60B 2200/00

(57) ABSTRACT

The invention relates to a Wheel Hex Hub Assembly designed for remote-controlled cars, offering adjustable features for convenient customization. The assembly comprises a Threaded Hex Hub, a Hub Face, and a Hub Spacer. The Threaded Hex Hub connects the wheel to the axle with a hex shape cutout and threaded holes for secure fastening. The Hub Face provides a flat surface with a machined cylindrical step for wheel centering and a central hole for axle shaft attachment. The Hub Spacer allows for length adjustment in the assembly.

### BACKGROUND

This invention pertains to the field of remote-controlled cars and, more specifically, to a Wheel Hex Hub Assembly facilitating the connection between wheels and axles with adjustable features. This invention solves the issue of needing different wheel hex hubs to achieve different backspacing measurements. This invention also solves the issue of achieving a 0-backspacing wheel measurement.

### BRIEF SUMMARY OF THE INVENTION

The invention relates to a Wheel Hex Hub Assembly designed for remote-controlled cars, offering adjustable features for convenient customization. The Wheel Hex Hub assembly consists of 3 main parts including an optional spacer for backspacing adjustment, and can be installed to achieve a 0-backspacing wheel measurement.

### BRIEF DESCRIPTION OF THE DRAWINGS

FIG. 1 front top perspective view of the first embodiment of the present invention.

FIG. 2 Front bottom perspective view of the first embodiment of the present invention.

FIG. 3 Front perspective view of the first embodiment of the present invention.

FIG. 4 Front bottom perspective view of the second embodiment of the present invention.

FIG. 5 Front top perspective view of the second embodiment of the present invention.

FIG. 6 Front view of the second embodiment of the present invention.

FIG. 7 Front bottom perspective view of the third embodiment of the present invention

FIG. 8 Front top perspective view of the third embodiment of the present invention.

FIG. 9 Front view of the third embodiment of the present invention.

FIG. 10 Front bottom perspective view of the fourth embodiment of the present invention.

FIG. 11 Front top perspective view of the fourth embodiment of the present invention.

FIG. 12 Front perspective view of the fourth embodiment of the present invention.

### DETAILED DESCRIPTION

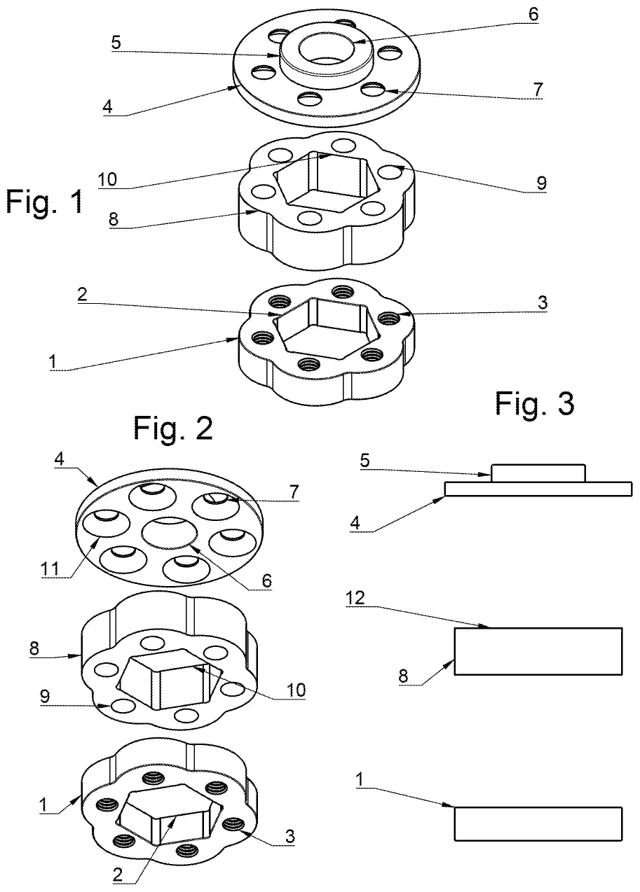

FIG. 1 front top perspective view of the first embodiment of the present invention, Wheel Hex Hub Assembly

The Wheel Hex Hub Assembly of FIG. 1 consists of three main components:

### Threaded Hex Hub 1:

Hexagonal hub 2 with a cutout for axle hex attachment.
Threaded holes 3 conforming to a standard remote control car wheel bolt pattern.

### Hub Face 4:

Flat face with a machined cylindrical step 5 for wheel centering.
Central hole 6 for axle shaft attachment.
Non-threaded holes 7 matching a standard remote control car wheel bolt pattern.

FIG. 2 Front bottom perspective view of the first embodiment of the present invention. In the embodiment of FIG. 2, Hub Face 4 is machined with conical shaped holes 11 to accommodate counter sink fasteners.

### Hub Spacer 8:

Spacer with holes in a standard remote control car wheel bolt pattern 9.
Positioned between the Hub Face 4 and Threaded Hex Hub 1 for length adjustment.

Front perspective view of the first embodiment of the present invention. In embodiment of FIG. 3, Hub Spacer 8 is not limited to a single measurement and can optionally use multiple Hub Spacers to adjust backspacing measurement.

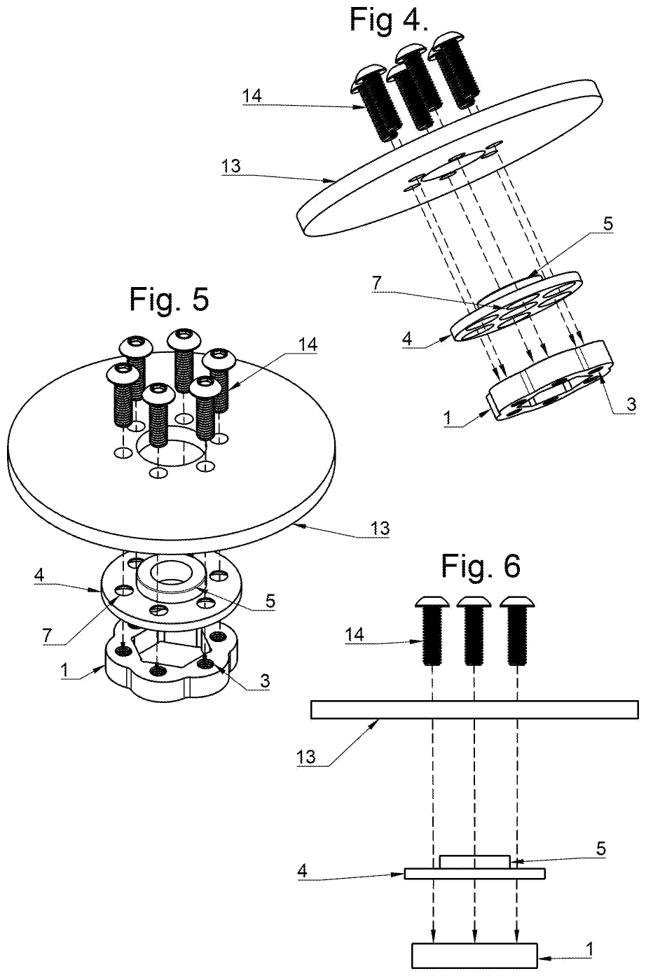

FIG. 4. Front bottom perspective view of the second embodiment of the present invention, Method to Fasten Wheel Hex Hub Assembly.

A method to fasten the Wheel Hex Hub Assembly of claim 1 to the wheel 13 of a remote-controlled car, comprising:
1. Place the Hub Face 4 onto the interior of the wheel 13 with the cylindrical step 5 facing inward, the wheel 13 being used to show the necessary orientation and location of installation and does not limit the scope of the invention.
2. Install fasteners 14 through the exterior of the wheel 13 and Hub Face 4 via non-threaded holes 7, the fasteners 14 being used to show the necessary orientation of installation and is not intended to limit the scope of the invention.
3. Align Fasteners 14 with threaded holes 3 on the Threaded Hex Hub 1.
4. Place the Threaded Hex Hub 1 on the backside of the Hub Face 4.
5. Fasten the wheel 13 and Hub Face 4 to the Threaded Hex Hub 1.
6. Tighten Fasteners 14 into the threaded holes 3 on the Threaded Hex Hub 1.

FIG. 5 Front top perspective view of the second embodiment of the present invention.

FIG. 6 Front view of the second embodiment of the present invention.

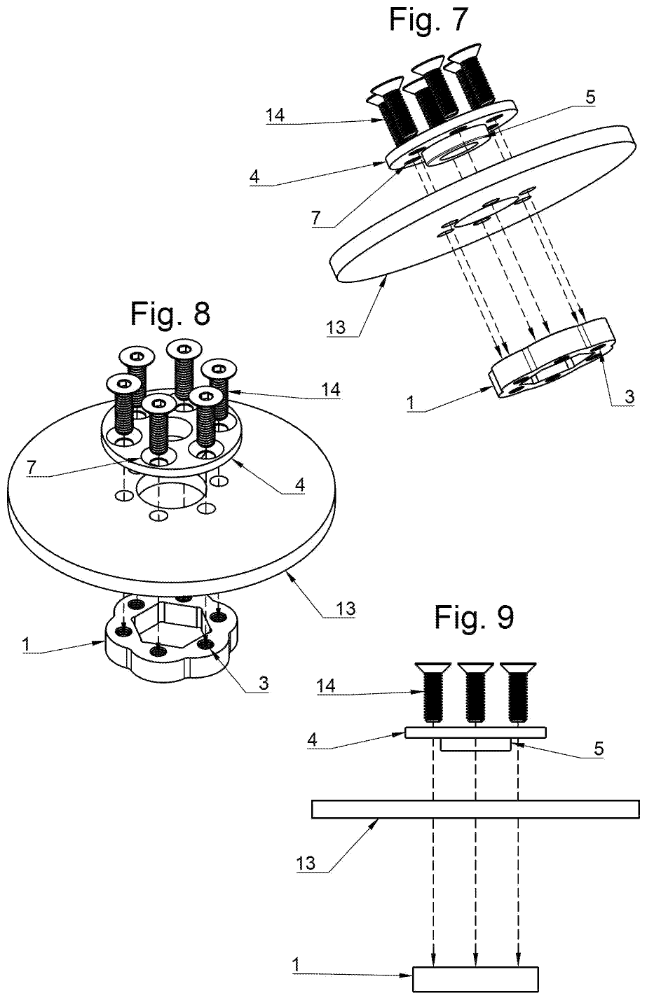

FIG. 7 Front bottom perspective view of the third embodiment of the present invention, 0-Backspacing Measurement Method.

A method to fasten the Wheel Hex Hub Assembly of claim 1 to the wheel 13 of a remote-controlled car with a 0-backspacing measurement, comprising:
1. Place the Hub Face 4 onto the exterior of the wheel 13 with the cylindrical step 5 facing inward.
2. Install Fasteners 14 through the exterior of the Hub Face 4 and wheel 13 via non-threaded holes 7.
3. Align Fasteners 14 with threaded holes 3 on the backside of the wheel 13.
4. Place the Threaded Hex Hub 1 on the backside of the wheel 13.
5. Fasten the wheel 13 and Hub Face 4 to the Threaded Hex Hub 1 using Fasteners 14.
6. Tighten Fasteners 14 into the threaded holes 3 on the Threaded Hex Hub 1.

FIG. 8 Front top perspective view of the third embodiment of the present invention.

FIG. 9 Front view of the third embodiment of the present invention.

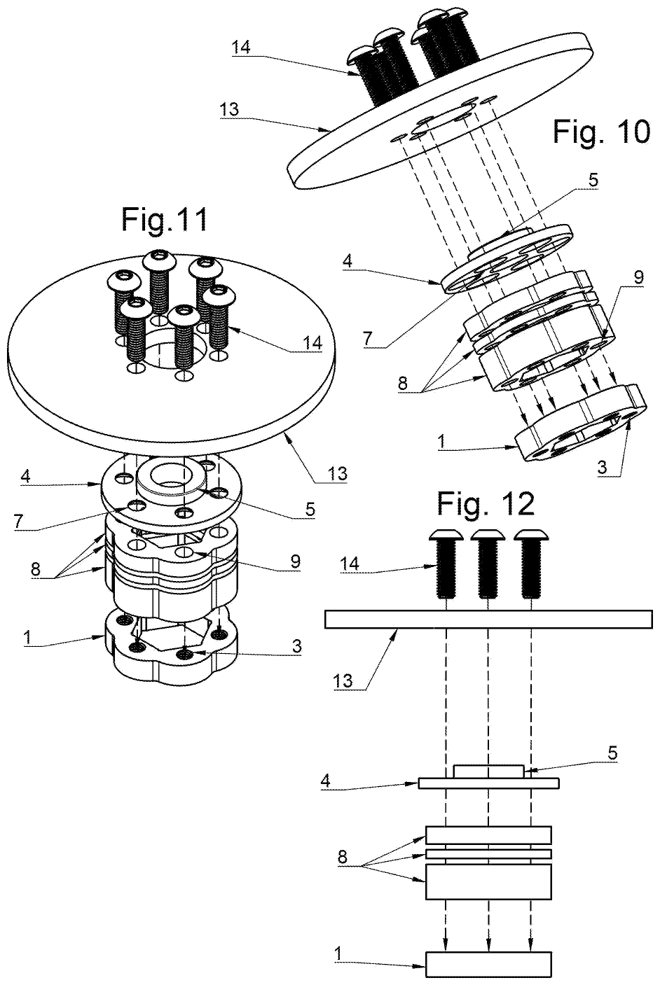

FIG. 10 Front bottom perspective view of the fourth embodiment of the present invention, Adjustable Backspacing Method:

A method to fasten the Wheel Hex Hub Assembly of claim 1 to the wheel 13 of a remote-controlled car with an Adjustable Backspacing measurement, comprising:
1. Place the Hub Face 4 onto the interior of the wheel 13 with the cylindrical step 5 facing inward.
2. Optionally, place Hub Spacer(s) 8 onto the Hub Face 4 from the back of the wheel 14 for backspacing adjustment, Hub Spacer(s) 8 may be of different length measurements.
3. Install fasteners 14 through the exterior of the wheel 13, Hub Face 4, and optional Hub Spacer(s) 8 via non-threaded holes 7 and 9.
4. Align fasteners 14 with threaded holes 3 on the Threaded Hex Hub 1.
5. Place the Threaded Hex Hub 1 on the backside of the Hub Face 4 or optional Hub Spacer(s) 8.
6. Fasten the wheel 13, Hub Face 4, and optional Hub Spacer(s) 8 to the Threaded Hex Hub 1.
7. Tighten fasteners 14 into the threaded holes 3 on the Threaded Hex Hub 1.

FIG. 11 Front top perspective view of the fourth embodiment of the present invention.

FIG. 12 Front perspective view of the fourth embodiment of the present invention.

### 4. Advantages:

Customizable backspacing for wheel alignment.
Versatile design compatible with standard remote control car wheel bolt patterns.
Simple and efficient fastening methods for various applications.

The Adjustable Wheel Hex Hub Assembly provides an innovative solution for remote-controlled car enthusiasts, allowing for easy customization and precise wheel alignment.

1: Wheel Hex Hub Assembly
A Wheel Hex Hub Assembly for remote-controlled cars, comprising:
Threaded Hex Hub:
A hexagonal hub with a cutout for axle hex attachment
Threaded holes conforming to a commonly used remote control car wheel bolt pattern
Hub Face:
A means to fasten the threaded hex hub onto the wheel using screws
Flat face with a machined cylindrical step for wheel centering.
A central hole for fastening the axle shaft onto the hex hub assembly using an axle nut.
Non-threaded holes in a commonly used remote control car wheel bolt pattern
Hub Spacer:
A means to extend or detract the overall length of the wheel hub assembly
Spacer with a commonly used remote control car wheel bolt pattern, installed between the hub face and threaded hex hub.
A means to install axle shaft through the Hub Spacer, a cutout limited to a minimum size of a commonly used remote control car axle shaft.

2: Method for Standard Installation
A method for fastening the Wheel Hex Hub Assembly of claim 1 to the wheel of a remote-controlled car, comprising:
Placing the Hub Face onto the interior of any remote-control car wheel surface with a commonly used bolt pattern, with the cylindrical step facing inward.
Installing Fasteners through the exterior of any remote-control car wheel with a commonly used bolt pattern and Hub Face via the six non-threaded holes.
Aligning the Fasteners with the threaded holes.
Placing the Threaded Hex Hub on the backside of the Hub Face.
Fastening the wheel and Hub Face to the Threaded Hex Hub.
Tightening the fasteners into the threaded holes on the Threaded Hex Hub.

3: Method for 0-Backspacing Measurement
A method for fastening the Wheel Hex Hub Assembly of claim 1 to the wheel of a remote-controlled car with a 0-backspacing measurement, comprising:
Placing the Hub Face onto the exterior of the wheel surface with the cylindrical step facing inward
Installing screws through the exterior of the Hub Face and wheel via the six non-threaded holes.
Aligning the screws with the threaded holes.
Placing the Threaded Hex Hub on the backside of the wheel.
Fastening the wheel and Hub Face to the Threaded Hex Hub.
Tightening the screws into the threaded holes of the Threaded Hex Hub.

4: Method for Adjustable Backspacing Measurement
A method for installing the wheel hex hub assembly of claim 1 to the wheel of a remote-controlled car, wherein the backspacing measurement is adjustable, comprising:
Placing the Hub Face onto the interior of the wheel surface with the cylindrical step facing inward
Optionally placing Hub Spacer(s) onto the Hub Face from the back of the wheel for backspacing adjustment
Installing screws through the exterior of the wheel, Hub Face, and optional Hub Spacer(s) via the six non-threaded holes
Aligning the screws with the threaded holes on the Threaded Hex Hub
Placing the Threaded Hex Hub on the backside of the Hub Face or optional Spacer(s)
Fastening the wheel, Hub Face, and optional Hub Spacer(s) to the Threaded Hex Hub
Tightening the screws into the threaded holes on the Threaded Hex Hub.
